(19) United States
(12) Patent Application Publication
(10) Pub. No.: US 2002/0114658 A1
(43) Pub. Date: Aug. 22, 2002

(54) Combination toothbrush/dentifrice dispenser

(76) Inventors: Michael R. Allen, Boise, ID (US); Steven P. Helleck, Boise, ID (US); Patrick Harvey Johnson, Boise, ID (US); Edgar T. Randol, Boise, ID (US)

Correspondence Address: Joseph W. Holland, P.O. Box 1840, Boise, ID, 83701-1840, US

(21) Appl. No.: 09/792,201

(22) Filed: Feb. 22, 2001

(51) Int. Cl. A47L 13/22; A46B 11/04; B43K 5/06

(52) U.S. Cl. 401/176; 401/270

(57) ABSTRACT

A combination toothbrush/dentifrice dispenser including a handle, the handle including an internal cavity forming a dentifrice reservoir for containing a dentifrice. The handle includes an elongated slot formed through a sidewall of the handle. A neck attaches to and extends from the handle and a brush head including bristles is formed at the distal end of the neck. The neck segment is contiguous to the handle and a conduit extends through the brush head and the neck segment. One end of the conduit forms an output orifice. A plunger is slideably disposed within the reservoir and a slide actuator is connected to the plunger and extends through the slot formed through the sidewall of the handle. When pressure is applied to the slide actuator, dentifrice is advanced through the conduit to dispense at the brush head.

### BACKGROUND OF THE INVENTION

1. Technical Field

The present invention relates to combination toothbrush/dentifrice dispensers and more particularly to a tooth brush having a reservoir for containing a dentifrice and a means of manually supplying the dentifrice to the brush head and bristles.

2. Background

Toothbrushes having a reservoir and a means for dispensing a dentifrice to a brush head from the reservoir have been previously suggested. It has been demonstrated that such a combination is considered particularly useful in a variety of settings, including hospitals, hotels and other providers of accommodations to travelers, the military and disaster relief agencies.

Combination toothbrush/dentifrice dispensers of the prior art lack simplicity and ease of use or economic cost of manufacture.

U.S. Pat. No. 5,026,191 to Akly entitled Rechargeable and Disposable Toothbrush discloses a toothbrush including a toothpaste storage compartment in the handle and a rotary mechanism for enabling toothpaste in the toothpaste storage compartment to be urged through a conduit in a head directly to the bristles. A piston forces the toothpaste out of the handle into a conduit formed through the brush head. The piston is advanced by operation of a knob which rotates a screw which in turn carries follower which includes keys for tracking in a slot to prohibit rotation of the follower.

U.S. Pat. No. 5,439,014 to Moussa, entitled Toothbrush with Toothpaste Reservoir discloses a refillable toothbrush having a toothpaste reservoir. The handle of the brush is fitted with a flexible bellows and the toothbrush head with minute holes. When the bellows is depressed liquid toothpaste emerges onto the brush head. This invention has the drawback of being limited to use of a liquid dentifrice.

U.S. Pat. No. 5,908,257 to Martin entitled Toothpaste Dispensing Toothbrush discloses a toothbrush having a hollow handle and a brush head formed integrally at the top end of the handle. A disposable toothpaste containing cartridge is supported within the handle, and a piston is adapted to force the toothpaste out of the handle into a conduit formed through the brush head. The piston is advanced by operation of a knob which rotates a screw which in turn carries follower.

U.S. Pat. No. 5,918,996 to Coolbaugh, entitled Combination Toothbrush and Toothpaste Dispenser discloses a combination toothbrush and toothpaste dispenser including a cylindrical handle configured to hold toothpaste within a reservoir formed within the handle. A toothpaste propelling portion in the form of a twistable knob, a threaded screw, and a screw driven follower or piston is disposed within the cylindrical handle. When the knob is turned the piston moves within the handle to force dentifrice through the brush head and into an outlet passage exiting the toothbrush head between the bristles.

U.S. Pat. No. 6,009,886 to Labranche, et al., entitled Dentifrice and Floss Dispensing Toothbrush discloses a toothbrush which dispenses both dentifrice and dental floss. The toothbrush includes a tubular handle integrally connected to a toothbrush neck and toothbrush head, over which a protective sheath having a floss dispenser is removably attached. A dentifrice dispensing mechanism is provided to drive a supply of dentifrice contained in the tubular handle through a duct and conduit in the toothbrush neck and head. The dispensing mechanism includes a twistable knob, a threaded screw, and a screw driven follower or piston. When the knob is turned the piston moves within the handle to force dentifrice through the brush head and into an outlet passage exiting the toothbrush head between the bristles.

U.S. Pat. No. 6,142,694 to Rivlin, et al., entitled Toothbrush with Reservoir for Dentifrice discloses a disposable toothbrush with a built-in reservoir for dentifrice including a dispensing mechanism for forcing the dentifrice from the storage compartment through a conduit to the bristles. In this case, the dispensing mechanism includes a piston, a cord, and a rotatable spindle having a knob. When the knob is turned the cord winds onto the spindle pulling the piston through the handle to force dentifrice through the brush head and into an outlet passage exiting the toothbrush head between the bristles.

There are drawbacks with the prior art. First, as disclosed by Akly, Martin, Coolbaugh and Labranche, et at., the dispensing mechanism includes a screw, and a screw driven follower or piston. Assemblies including screws and threaded components typically demand stricter adherence to manufacturing tolerances and accordingly are more costly to manufacture. Additionally, knobs, particularly relatively small knobs as disclosed by Akly, Martin, Coolbaugh, Labranche, et al. and Rivlin et al., may be difficult for some users to grasp or operate. Additionally, it is relatively difficult, with the dispensing mechanisms disclosed by Akly, Moussa, Martin, Coolbaugh, Labranche, et al. and Riviun et al., to consistently repeat or replicate the amount of dentifrice dispensed with each use.

It would be desirable to have a combination toothbrush/dentifrice dispenser that includes a dentifrice reservoir, a dentifrice contained within the dentifrice reservoir and a dispensing mechanism that does not include screws or threaded components. It would also be desirable to have a combination toothbrush/dentifrice dispenser that does not rely on a knob or other rotatable member for advancing the dentifrice through the conduit to the orifice. It would also be desirable to have a combination toothbrush/dentifrice dispenser that provides a simple plunger design having an integral sealing leading edge. It would also be desirable to have a combination toothbrush/dentifrice dispenser that provides a dentifrice orifice configured as a filler orifice means to permit filling the reservoir through the filler orifice. It would also be desirable to have a combination toothbrush/dentifrice dispenser that provides a metering element which allows for a predetermined and substantially repeatable amount of dentifrice to be dispensed upon each use.

Therefore, one object of the present invention is to provide a combination toothbrush/dentifrice dispenser that does not rely on a knob or other rotatable member for advancing the dentifrice through the conduit to the orifice.

Another object of the present invention is to provide a combination toothbrush/dentifrice dispenser that provides a simple plunger design having an integral sealing leading edge.

Another object of the present invention is to provide a combination toothbrush/dentifrice dispenser that provides a metering element which allows for a predetermined and substantially repeatable amount of dentifrice to be dispensed upon each use.

Another object of the present invention is to provide a combination toothbrush/dentifrice dispenser that provides an option of filling the dentifrice reservoir during manufacture either at the heel or through the head.

### SUMMARY OF THE INVENTION

The present invention is directed to a combination toothbrush/dentifrice dispenser including a handle, the handle including an internal cavity forming a dentifrice reservoir for containing a dentifrice. The handle includes an elongated slot formed through a sidewall of the handle. A neck attaches to and extends from the handle and a brush head including bristles is formed at the distal end of the neck. The neck segment is contiguous to the handle and a conduit extends through the brush head and the neck segment. A first end of the conduit fluidly communicates with the dentifrice reservoir and a second end of the conduit fluidly communicates with the brush head. The second end of the conduit forms an output orifice. In one embodiment of the invention, the output orifice is configured as a filler orifice. The filler orifice is configured to mate and fluidly communicate with a nozzle connected to a pressurized source of dentifrice. This feature permits the reservoir to be filled through the dentifrice orifice after the combination toothbrush/dentifrice dispenser has been assembled.

In one embodiment of the invention, the conduit extends through the brush head and the neck segment is configured having an oversized cross-sectional diameter. This aspect of the invention results in a lowered pressure against the movement of the dentifrice through the conduit. This facilitates both filling of the reservoir through the dentifrice orifice as well as the use of a slide actuated plunger, as the plunger may be advanced in either direction with less pressure.

A plunger is slideably disposed within the reservoir and a slide actuator is connected to the plunger and extends through the slot formed through the sidewall of the handle. In one embodiment of the invention, the plunger is configured having a sealing leading edge which acts to scrape or squeegee the interior sidewall of the reservoir as the plunger advances through the internal cavity of the handle. The plunger may further be configured having a concave nose which also facilitates the scraping action of the interior sidewall of the reservoir as the plunger advances through the internal cavity of the handle.

To dispense dentifrice at the head, pressure is simply applied against the slide actuator.

Additional objects, advantages and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a combination toothbrush/dentifrice dispenser;

FIG. 2 is a first side of a combination toothbrush/dentifrice dispenser;

FIG. 3 is a top view of a combination toothbrush/dentifrice dispenser;

FIG. 4 is a second side view of a combination toothbrush/dentifrice dispenser;

FIG. 5 is a bottom view of a combination toothbrush/dentifrice dispenser;

FIG. 6 is a first end view of a combination toothbrush/dentifrice dispenser;

FIG. 7 is a second end view of a combination toothbrush/dentifrice dispenser;

FIG. 8 is a side sectional view of a combination toothbrush/dentifrice dispenser;

FIG. 9 is an exploded top view of a combination toothbrush/dentifrice dispenser;

FIG. 10 is a partial sectional side view of a combination toothbrush/dentifrice dispenser; and

FIG. 11 is a top view of a combination toothbrush/dentifrice dispenser.

### DETAILED DESCRIPTION OF THE INVENTION

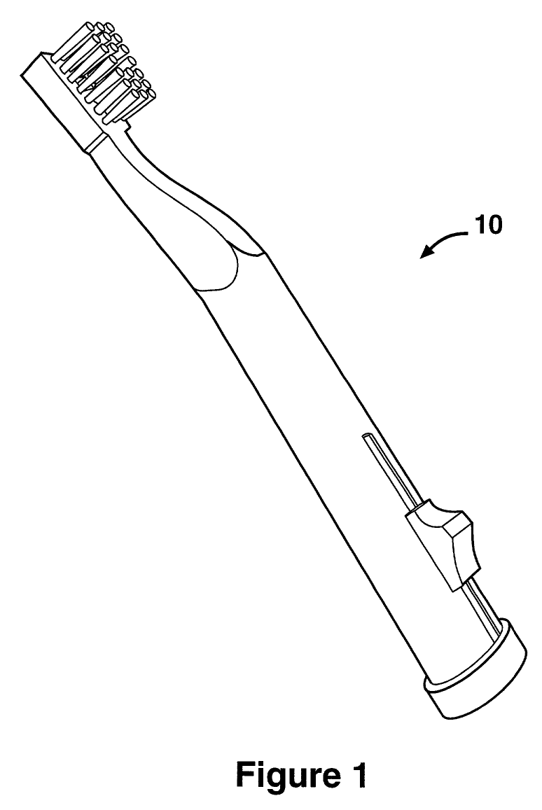

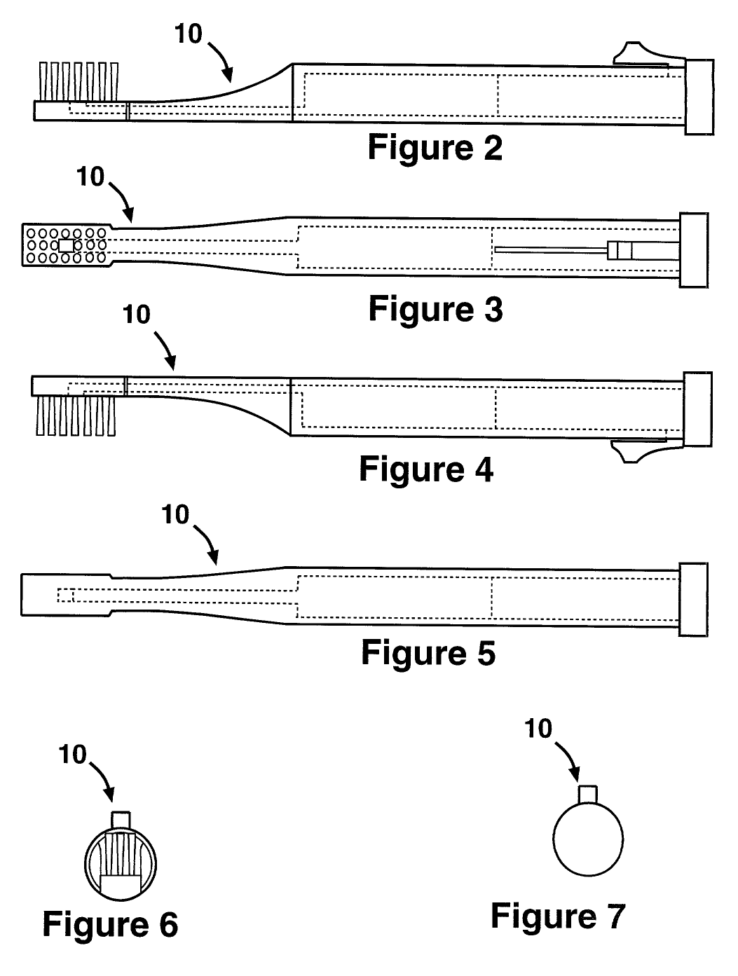

Referring now to FIGS. 1 through 7, a first embodiment is shown of combination toothbrush/dentifrice dispenser 10.

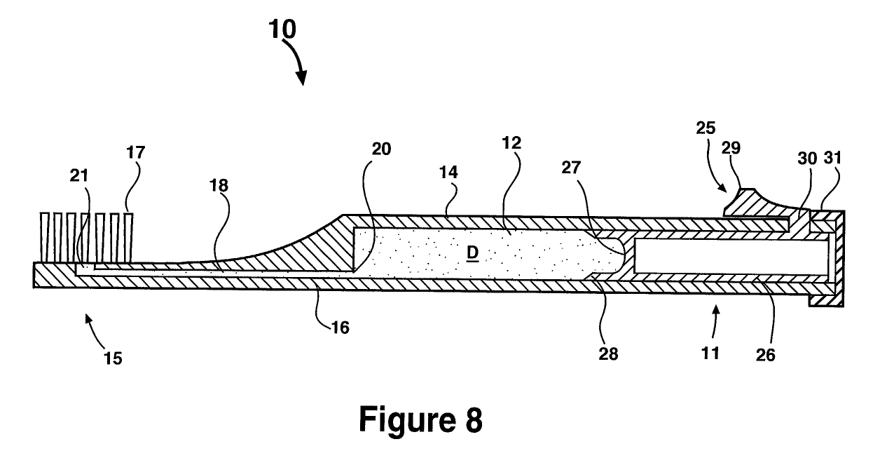

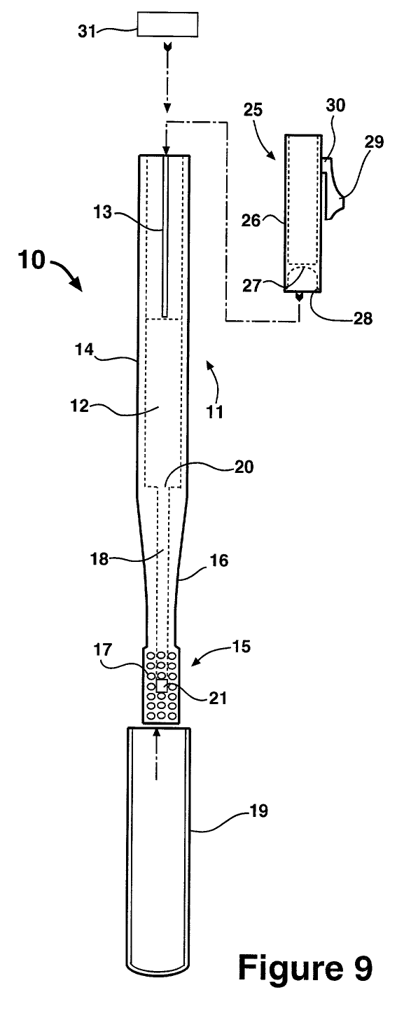

Referring to FIGS. 8 through 11, combination toothbrush/dentifrice dispenser 10 is shown including handle 11, having an internal cavity forming dentifrice reservoir 12 for containing a dentifrice. As shown in FIGS. 9, handle 11 includes an elongated slot 13 formed through sidewall 14 of handle 11. Brush head 15 is attached to handle 11 by neck 16. Bristles 17 are affixed in brush head 15. Conduit 18 extends through neck 16 extending through brush head 15. Conduit first end 20 fluidly communicates with the dentifrice reservoir and output orifice 21 fluidly communicates with brush head 15.

As shown in FIGS. 8 and 9, combination toothbrush/dentifrice dispenser 10 also includes slide actuator assembly 25. Slide actuator assembly 25 includes plunger 26, which in the embodiment shown includes concave tip 27 having tapered leading edge 28. Plunger 26 is advanced through reservoir 12 by means of pressure exerted against slide actuator 29. Slide actuator 29 is attached to plunger 26 by arm 30 which extends through slot 13. Combination toothbrush/dentifrice dispenser 10 also includes stop 31 and brush head cover 19.

In one embodiment of the invention, conduit 18 and output orifice 21 are configured having a cross-sectional diameter in the range of ⅛″ to ⅜″. This relatively oversized cross-sectional diameter produces less restriction to the flow of dentifrice both upon filling and upon dispensing through conduit 18 and output orifice 21. This aspect of the invention results in a lowered pressure against the movement of dentifrice D through conduit 18. This feature of the invention facilitates filling of reservoir 12 through output orifice 21. This feature of the invention also facilitates dispensing dentifrice from reservoir 12 through output orifice insofar as less resistance is produced to the movement of dentifrice D through conduit 18 and therefor less pressure must be exerted against plunger 25, as the plunger may be advanced in either direction with less pressure.

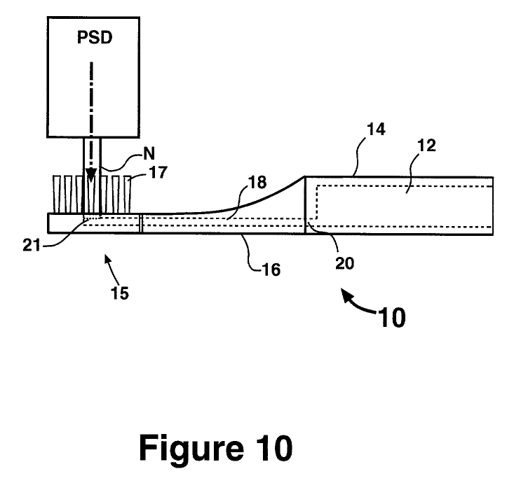

FIG. 10 is a partial sectional side view of the combination toothbrush/dentifrice dispenser 10 wherein output orifice 21 is configured to mate and fluidly communicate with nozzle N connected to pressurized source of dentifrice PSD. This feature permits dentifrice reservoir 12 to be filled through output orifice 21 after the combination toothbrush/dentifrice dispenser has been assembled.

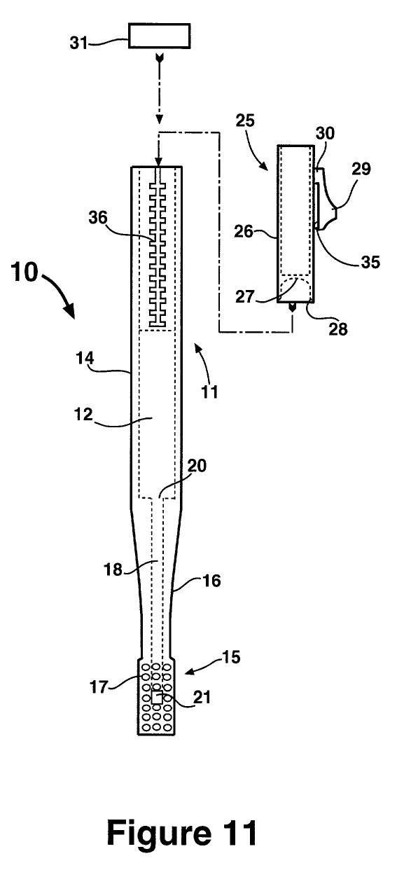

FIG. 11 shows combination toothbrush/dentifrice dispenser 10 including slide actuator assembly 25 having plunger 26 with concave tip 27 and tapered leading edge 28. Slide actuator 29 is attached to plunger 26 by arm 30 which extends through slot 13. Slide actuator 29 is configured having tooth 35 which engages indexing member 36 permitting a measured dispensing of dentifrice D.

While there is shown and described the preferred embodiment of the invention, it is to be distinctly understood that this invention is not limited thereto but may be variously embodied to practice within the scope of the following claims.

We claim:

1. A combination toothbrush/dentifrice dispenser comprising:
a handle, including an internal cavity forming a dentifrice reservoir, the handle including an elongated slot formed through a sidewall of the handle;
a brush head connected to a first end of the handle by a neck, the brush head including a plurality of bristles, the brush head including a conduit extending through the brush head and the neck segment, the conduit in fluid communication with the dentifrice reservoir and the brush head; and
a slide actuator assembly, including a plunger slideably disposed within the reservoir and a slide actuator connected to the plunger and extending through the slot formed through the sidewall of the handle.

2. The combination toothbrush/dentifrice dispenser of claim 1 further comprising a dentifrice contained within the reservoir.

3. The combination toothbrush/dentifrice dispenser of claim 1 wherein the plunger further comprises a sealing leading edge.

4. The combination toothbrush/dentifrice dispenser of claim 1 wherein the plunger further comprises a concave nose.

5. The combination toothbrush/dentifrice dispenser of claim 1 wherein the conduit further comprises an output orifice configured to mate and fluidly communicate with a source of dentifrice.

6. The combination toothbrush/dentifrice dispenser of claim 1 further comprising a stop engaged with a second end of the handle for sealing the plunger within the internal cavity of the handle.

7. The combination toothbrush/dentifrice dispenser of claim 1 further comprising a brush head cover configured to fit over the brush head.

8. The combination toothbrush/dentifrice dispenser of claim 1 further comprising a metering element including an indexing member formed along a marginal edge of the slot and a tooth formed on the slide actuator for engagement with the indexing member.
